(19) United States
(12) Patent Application Publication
(10) Pub. No.: US 2025/0019318 A1
(43) Pub. Date: Jan. 16, 2025

(54) UNDER-SINK COMPOSTING DEVICE

(71) Applicant: Kraus USA Plumbing LLC, Port Washington, NY (US)

(72) Inventors: Serhiy Torak, Brooklyn, NY (US); Todd Alexander, Hollis, NH (US)

(21) Appl. No.: 18/770,239

(22) Filed: Jul. 11, 2024

Related U.S. Application Data
(60) Provisional application No. 63/526,926, filed on Jul. 14, 2023.

(51) Int. Cl. C05F 17/907; B01D 53/04; B09B 3/40; B09B 3/60; B09B 101/70; C05F 9/04; C05F 17/30; C05F 17/40; C05F 17/60; C05F 17/70; C05F 17/921; C05F 17/979; E03C 1/266

(52) U.S. Cl. CPC C05F 17/907; B01D 53/04; B09B 3/40; B09B 3/60; C05F 9/04; C05F 17/30; C05F 17/40; C05F 17/60; C05F 17/70; C05F 17/939; C05F 17/979; B01D 2253/102; B01D 2257/90; B09B 2101/70; E03C 1/266

(57) ABSTRACT

An under-sink composting device configured to operably couple with a garbage disposal. The composting device includes a waste separator for separating solid waste from liquid in an organic waste material.

### CROSS-REFERENCE TO RELATED APPLICATION

The present application claims priority to U.S. Provisional Patent Application Ser. No. 63/526,926, filed Jul. 14, 2023, the disclosure of which is expressly incorporated herein by reference.

### BACKGROUND AND SUMMARY OF THE DISCLOSURE

The present invention relates generally to a composting device and, more particularly, to a composting device that connects to a garbage disposal under a sink.

In a typical kitchen, organic waste, such as food scraps are usually generated. Such organic waste is often either thrown into a trash receptacle or passed through a garbage disposal under the sink to a drain. As such, there is a desire to dispose of such organic waste in a more environmentally friendly manner, such as via composting.

According to an illustrative embodiment of the present disclosure, a composting device for processing organic waste material from a sink drain includes a waste material inlet configured to operably couple with a sink drain, and a waste separator operably coupled to the waste material inlet. The waste separator is configured to separate solid waste from liquid in the organic waste material. The waste separator includes an outer case extending axially between a proximal end and distal end, the outer case having a sidewall with a plurality of openings positioned intermediate an inlet opening and an outlet opening. A rotatable screw is received within the outer case, and an actuator is operably coupled to the rotatable screw to cause the screw to rotate and move the waste material axially in a direction from the proximal end to the distal end. A storage bin is positioned to receive the solid waste from the outlet opening of the outer case of the waste separator. A heater is in thermal communication with the storage bin to facilitate dehydrating of the solid waste. A liquid outlet is fluidly coupled to the waste separator for discharging liquid extracted from the organic waste material.

According to another illustrative embodiment of the present disclosure, a composting device for processing organic waste material from a sink drain includes a waste material inlet configured to operably couple with a sink drain, and a waste separator operably coupled to the waste material inlet. The waste separator is configured to separate solid waste from liquid in the organic waste material. A storage bin is positioned to receive the solid waste from the waste separator. A heater is in thermal communication with the storage bin to facilitate dehydrating of the solid waste. A liquid outlet is fluidly coupled to the waste separator for discharging liquid extracted from the organic waste material. A controller is operably coupled to the actuator of the waste separator and the heater. A housing receives the waste separator and the heater, wherein the storage bin is removably received within the housing. A fill sensor is operably coupled to the controller and is configured to detect a level of solid waste within the storage bin.

According to a further illustrative embodiment of the present disclosure, a composting device for processing organic waste material from a sink drain includes a waste material inlet configured to operably couple with the sink drain, and a waste separator operably coupled to the waste material inlet. The waste separator is configured to separate solid waste from liquid in the organic waste material. The waste separator includes an outer case extending axially between a proximal end and a distal end, the outer case having a sidewall with a plurality of openings positioned intermediate in an inlet opening and outlet opening. A rotatable screw is received within the outer case, and an actuator is operably coupled to the rotatable screw to cause the screw to rotate and move the waste material axially in a direction from the proximal end to the distal end. A storage bin is positioned to receive the solid waste from the outlet opening of the outer case of the waste separator. A heater in thermal communication with the storage bin to facilitate dehydrating of the solid waste. A liquid outlet is fluidly coupled to the waste separator for discharging liquid extracted from the organic waste material. A controller is operably coupled to the actuator of the waste separator and the heater. A housing receives the waste separator and the heater, wherein the storage bin is removably received within the housing. A fill sensor is operably coupled to the controller and is configured to detect a level of solid waste within the storage bin. A garbage disposal is fluidly coupled to the sink drain.

Additional features and advantages of the present invention will become apparent to those skilled in the art upon consideration of the following detailed description of the illustrative embodiment exemplifying the best mode of carrying out the invention as presently perceived.

### BRIEF DESCRIPTION OF THE DRAWINGS

A detailed description of the drawings particularly refers to the accompanying figures, in which:

FIGS. 1A and 1B are perspective views, in partial schematic, of an illustrative composting device of the present disclosure operably coupled to a sink drain;

FIG. 2 is a perspective view, in cross-section, of the composting device of the present disclosure;

FIG. 3 is another perspective view, in cross-section, of the composting device of FIG. 2;

FIG. 4 is a perspective view, in cross-section, of a further illustrative composting device of the present disclosure;

FIG. 5 is a perspective view, in cross-section, of a further illustrative embodiment composting device of the present disclosure;

FIG. 6 is a diagrammatic view of another illustrative composting device of the present disclosure operably coupled to a sink drain;

FIG. 7 is a first perspective view of the composting device of FIG. 6;

FIG. 8 is a second perspective view of the composting device of FIG. 6;

FIG. 9 is a first cross-sectional view of the composting device of FIG. 6;

FIG. 10 is a second cross-sectional view of the composting device of FIG. 6;

FIG. 11 is a first perspective view of the composting device of FIG. 6, with the cover removed for clarity;

FIG. 12 is a second perspective view of the composting device of FIG. 6, with the cover removed for clarity;

FIG. 13 is a block diagram of representative electrical components of illustrative composting devices of the present disclosure;

FIG. 14 is a front perspective view, in cross-section, of a further illustrative composting device of the present disclosure;

FIG. 15 is another front perspective view, in cross-section, of the composting device of FIG. 14;

FIG. 16 is a rear perspective view of the composting device of FIG. 14; and

FIG. 17 is a perspective view of illustrative fluid pathways of the composting device of FIG. 14.

### DETAILED DESCRIPTION OF THE DRAWINGS

For the purposes of promoting and understanding the principles of the present disclosure, reference will now be made to the embodiments illustrated in the drawings, which are described herein. The embodiments disclosed herein are not intended to be exhaustive or to limit the invention to the precise form disclosed. Rather, the embodiments are chosen and described so that others skilled in the art may utilize their teachings. Therefore, no limitation of the scope of the claimed invention is thereby intended. The present invention includes any alterations and further modifications of the illustrated devices and described methods and further applications of principles in the invention which would normally occur to one skilled in the art to which the invention relates.

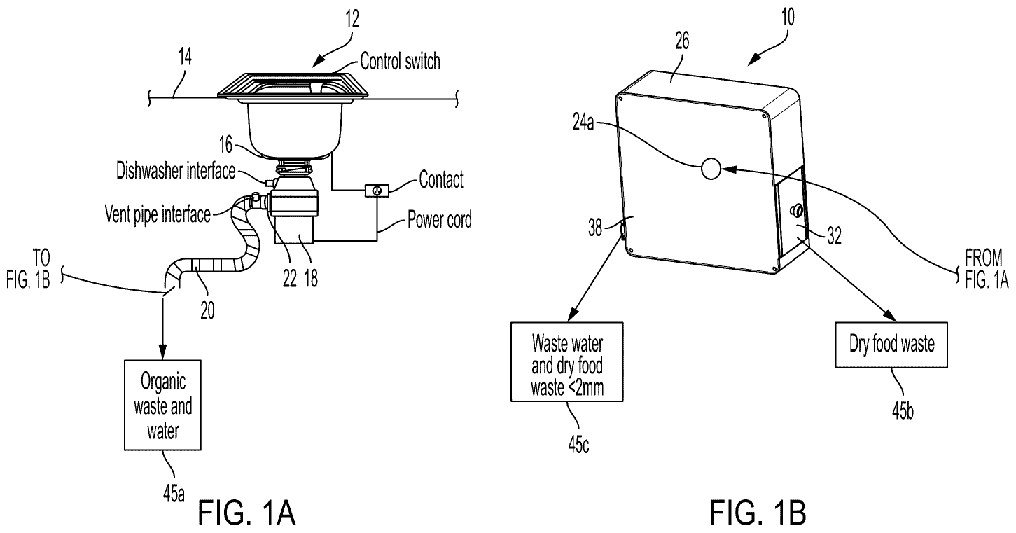

Referring initially to FIGS. 1A and 1B, an illustrative composting device 10 of the present disclosure is shown for positioning below a sink 12 supported by a mounting deck 14. More particularly, FIG. 1A illustrates a conventional sink 12 supported by the mounting deck 14 and including a sink drain 16 fluidly coupled to a garbage disposal 18. A conduit 20, illustratively a flexible tube, fluidly couples an outlet 22 of the garbage disposal 18 to a waste material housing inlet 24 of the composting device 10.

As is known, the illustrative garbage disposal 18 is of conventional design as being an electrically operable device configured to receive organic waste (such as food waste) flowing with water supplied via a faucet (not shown) through the sink drain 16, and to shred or grind the organic waste into smaller particles or pieces (e.g., less than about 2 millimeters in diameter).

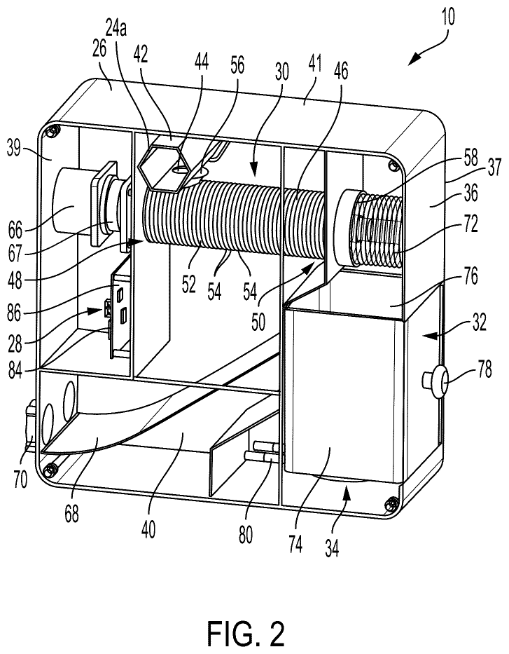

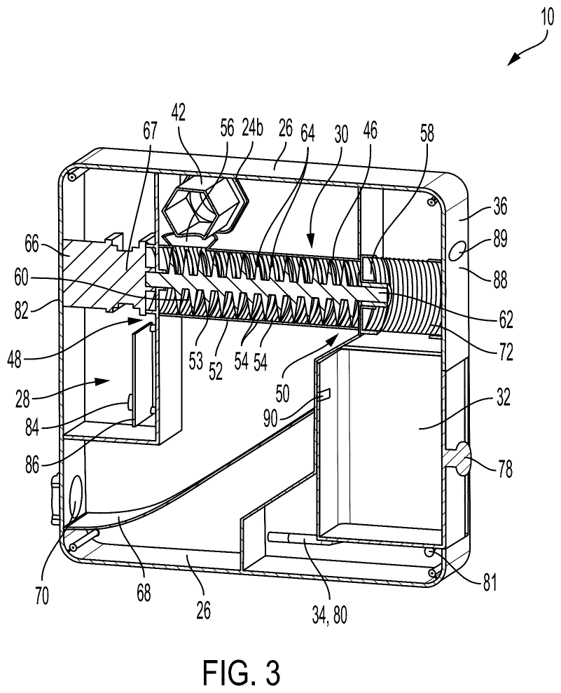

With reference to FIGS. 2 and 3, the composting device 10 illustratively includes a housing 26 receiving a controller 28, a waste separator 30, a storage bin or recycling tank 32, and a heater 34. The housing 26 illustratively includes a center support 36 operably coupled to a first or left cover 38 and a second or right cover 40. The center support 36 illustratively includes a front wall 37 and a rear wall 39 supporting a top wall 41. The inlet 24 includes a left inlet 24a and a right inlet 24b defined by an inlet pipe 42 extending between the left cover 38 and the right cover 40 for fluidly connecting to the garbage disposal 18 via the conduit 20. The waste material inlet pipe 42 includes an outlet opening 44 providing fluid communication between the inlets 24a, 24b and the waste separator 30.

More particularly, the waste separator 30 is operably coupled to the waste material inlet 24 via the inlet pipe 42 to receive organic waste material and water 45a from the garbage disposal 18. The waste separator 30 is configured to separate solid waste 45b (e.g., dry food waste) from liquid 45c (e.g., waste water and small particle solid waste, such as dry food waste less than 2 millimeters in size) in the organic waste and water 45a from the garbage disposal 18.

The waste separator 30 illustratively includes an outer case 46 extending axially between a proximal end 48 and a distal end 50. The outer case 46 illustratively includes a cylindrical side wall 52 with a draining mesh 53. The draining mesh 53 illustratively includes a plurality of openings 54 positioned intermediate an inlet opening 56 (adjacent the proximal end 48) and an outlet opening 58 (adjacent the distal end 50). The organic waste and water 45a from the garbage disposal 18 is supplied to the inlet opening 56, while the separated solid waste 45b is supplied to the outlet opening 58.

With reference to FIG. 3, a rotatable screw 60 is received within the outer case 46. The rotatable screw 60 illustratively includes a center shaft 62 supporting a plurality of helical threads or discs 64. A drive actuator 66, illustratively a direct current (DC) electric motor, is operably coupled to the rotatable screw 60 illustratively via a gear assembly 67. Operation of the drive actuator 66 causes the screw 60 to rotate, such that the threads move the waste material axially in a direction from the proximal end 48 to the distal end 50.

A diverter wall 68 is illustratively positioned within the housing 26 below the separator 30. The diverter wall 68 is configured to direct liquid, extracted from the waste separator 30 and passing through the openings 54 in the side wall 52, to a liquid housing outlet 70 supported by the housing 26. The outlet 70 is fluidly coupled to a conventional sewer drain 71 to discharge waste water and small particle waste 45b.

Illustratively, an outlet grate 72 is operably coupled to the outlet opening 58 of the waste separator 30. The storage bin 32 is illustratively positioned to receive the solid waste from the outlet opening 58 of the outer case 46 of the waste separator 30 via the outlet grate 72. The storage bin 32 is removable supported within the housing 26. More particularly, the storage bin 32 may be slidably received within the housing 26 below the outlet grate 72. The storage bin 32 illustratively includes a side wall 74 defining an open top 76. A handle 78 is coupled to the side wall 74 to facilitate removal of the storage bin 32 by a user. A stirring device (not shown) may be operably coupled to the storage bin 32 to stir the waste material stored therein and facilitate composting. A carbon filter (not shown) may also be operably coupled to the storage bin 32 to reduce unpleasant odors.

The heater 34 is in thermal communication with the storage bin 32 to facilitate the hydrating of the solid waste received therein. The heater 34 may be of conventional design as including electrical heating elements or tubes 80 positioned below the storage bin 32. An interlock 81 may be provided to prevent removal of the storage bin 32 from the housing 26 when the heater 34 is active.

The controller 28 is illustratively in electrical communication with the actuator 66 and the heater 34. A conventional power supply adapter 82 is illustratively in electrical communication with the controller 28 and, hence, the actuator 66 and the heater 34. More particularly, the power supply adapter 82 is configured to electrically couple the controller 28 to a conventional power supply (e.g., an AC power source). The controller 28 may include a processor 84 supported on a printed circuit board (pcb) 86. The processor 84 is configured to execute machine readable instructions stored in the controller 28. A user interface, such as a control panel 88, is illustratively supported by the housing 26 and in electrical communication with the controller 28. The control panel 88 may provide input buttons in electrical communication with the controller 28 for operation of the device 10, along with indicators and/or a display panel to provide feedback to the user.

A fill or level sensor 90 may also be operably coupled to the storage bin 32 to provide a signal to the controller 28 when waste within the storage bin 32 reaches a predetermined fill level. An alarm 89 may be activated (such as an audible and/or visual alert) by the controller 28 when the predetermined fill level is detected by the sensor 90. The alarm 89 may be defined by the control panel 88 or separate therefrom.

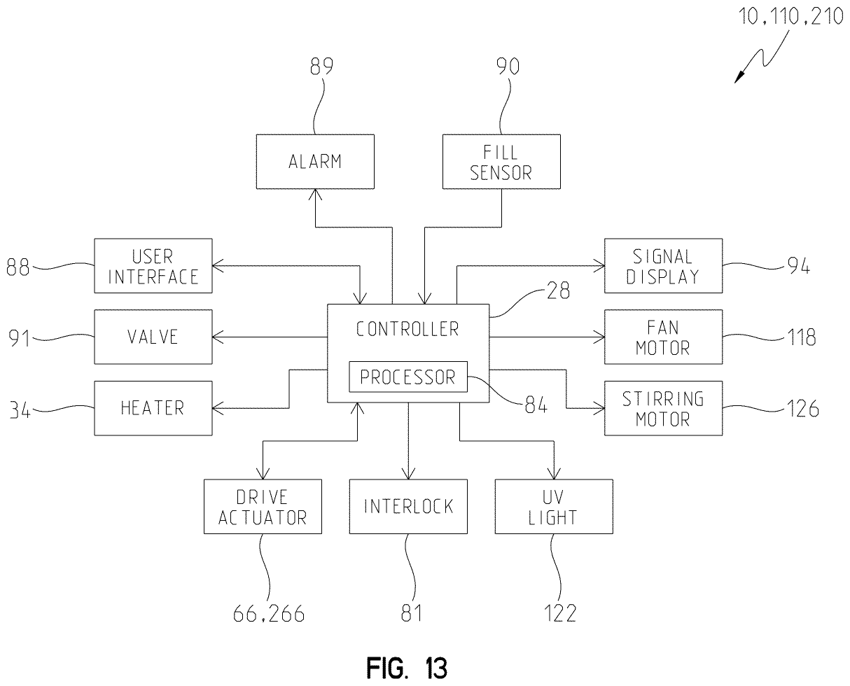

In certain illustrative embodiments, the waste separator 30 may include an electrically operable valve 91, such as a solenoid valve 91 (FIG. 13), in electrical communication with the controller 28. When the predetermined waste level has been detected by the sensor 90, then the controller 28 can activate the solenoid valve 91 to bypass organic waste and water supplied to the inlet 24 by the garbage disposal 18 directly to the liquid outlet 70. As such, the user does not need to empty the storage bin 32 each time it is full and can continue using the garbage disposal 18 uninterrupted.

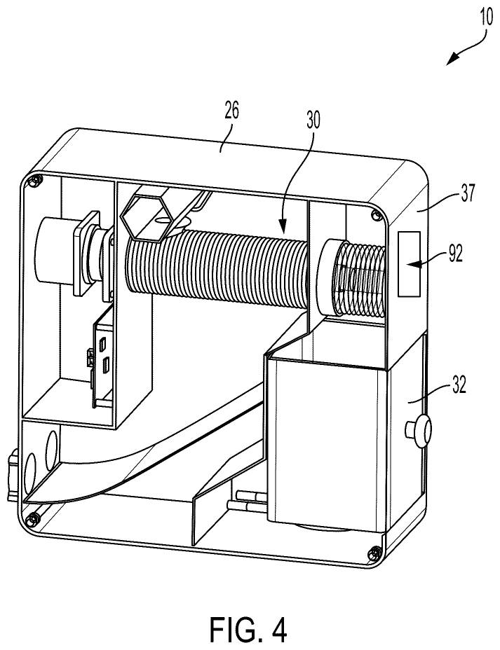

With reference to FIG. 4, a window 92 may be formed in the housing 26 illustratively within the front wall 37. The window 92 may be opened by a user to access the waster separator 30. More particularly, a user may pull the screw 60 and outer case 46 from the housing 26 for cleaning and/or maintenance. A sensor (not shown) may be operably coupled to the window 92, such that the controller 28 may provide an indication to the user when it is open and/or if the waste separator 30 is not properly installed.

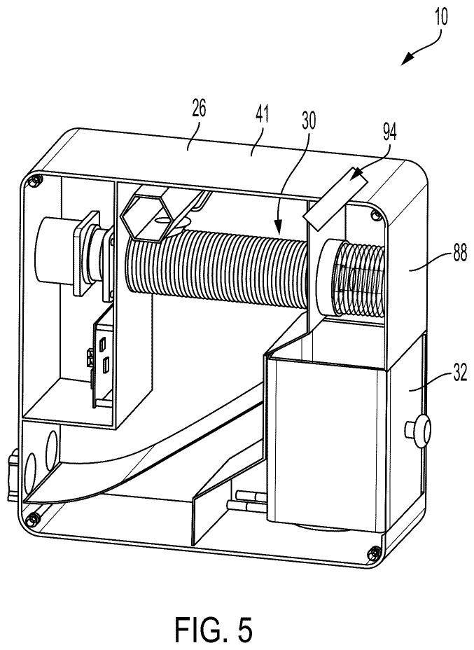

With reference to FIG. 5, a signal display 94 may be supported by the housing 26, illustratively by the upper wall 41. The signal display 94 may be defined by the control panel 88 or separate therefrom. The signal display 94 may include a light that is illuminated to provide an indication of power, operation of the motor 66 driving the screw 60, operation of the heater 34, storage bin 32 is full, and/or operational issues with the screw 60.

In operation, organic waste and water 45a from the sink drain 16 flows to the garbage disposal 18 where it is ground into smaller pieces. The controller 28 may start operation of the composting machine 10 (e.g., the actuator 60 and the heater 34) upon activation of the garbage disposal 18, illustratively via the control panel 88. The ground organic waste and water then passes from the outlet 22 of the garbage disposal 18 to the inlet 24 of the composting device 10 via the tube 20. The organic waste and water enters the waste separator 30 where it is pushed axially from the inlet opening 56 toward the outlet opening 58 via rotation of the screw 60. Liquid and small solid waste particles (e.g., less than about 2 millimeters) drain through the openings 54 of the outer case 46. The extracted liquid from the waste separator 30 is directed by the diverter wall 68 to the liquid outlet 70.

Large solid waste particles (e.g., greater than about 2 millimeters) are pushed by the screw 60 to the outlet grate 72 where they fall into the storage bin 32. The heater 34 may be activated to further dry the solid waste particles in the storage bin 32. The storage bin 32 may be slidably removed from the housing 26 and the micro-decomposed solid waste particles recycled (e.g., as soil compost). In an illustrative embodiment, the controller 28 causes the actuator 66 to continue operation of the screw 60 for a first predetermined time (e.g., around 5 to 10 minutes) and operation of the heater 34 for a second predetermined time (e.g., around 60 minutes) after the garbage disposal 18 has been deactivated.

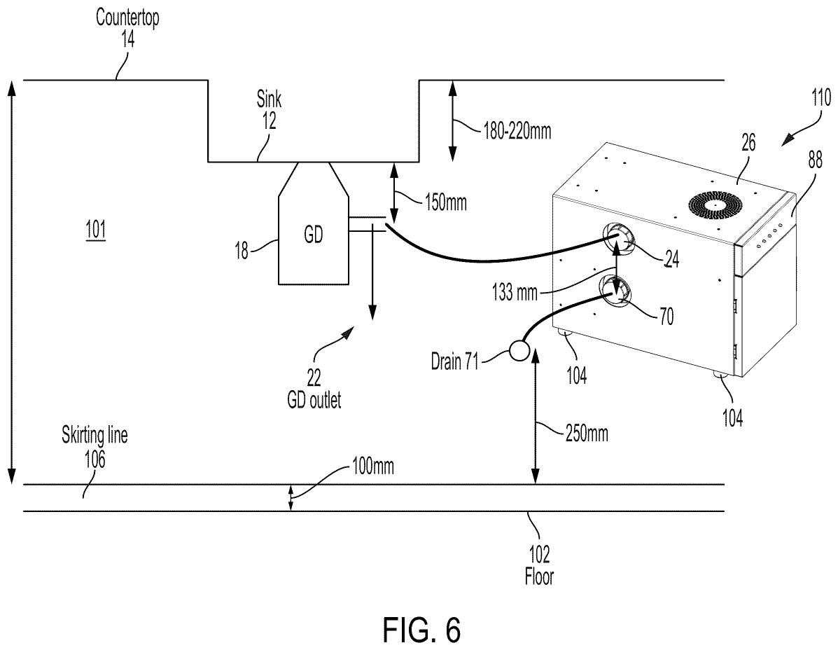

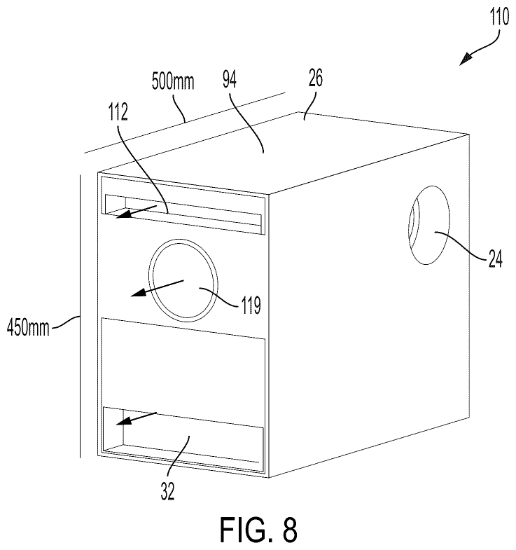

Referring now to FIGS. 6-12, a further illustrative embodiment composting device 110 of the present disclosure is shown as including many similar features to the composting device 10 detailed above. As such, in the following description, similar components will be identified with like reference numbers.

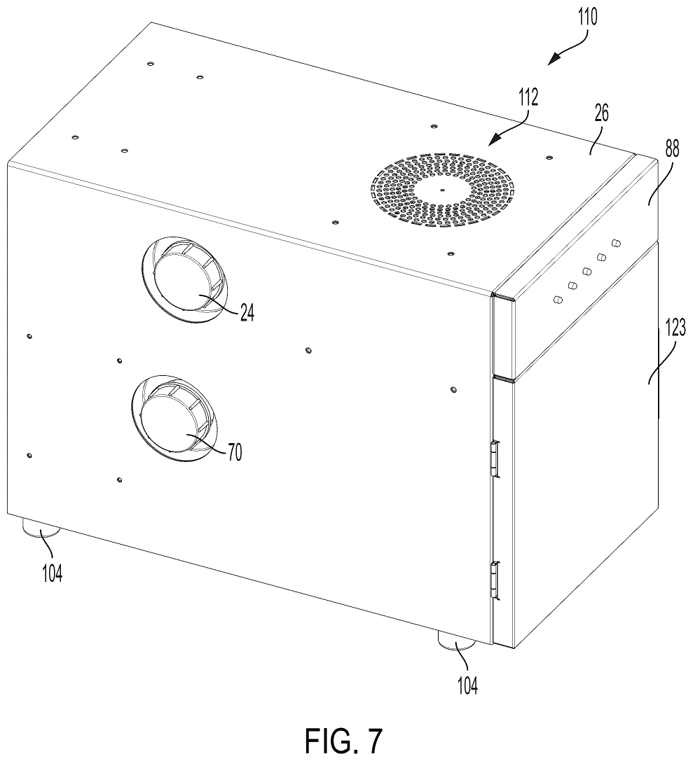

With reference to FIGS. 6 and 7, the illustrative composting device 110 is fluidly coupled between the outlet 22 of the garbage disposal 18 and the sewer drain 71. Different representative dimensions are shown in FIG. 6 for installing the composting device 110 within a cabinet 101 below the mounting deck 14 and above a floor 102. Illustratively, the cabinet 101 has an internal height of at least 750 millimeters (mm). Adjustable feet 104 may support the housing 26 above a skirting line or base 106 of the cabinet 101. Illustratively, the feet 104 are adjustable from 0 millimeters (mm) to 120 millimeters (mm) to assist in positioning the inlet 24 of the composting device 110 below the garbage disposal outlet 22, and positioning the outlet 70 of the composting device 110 above the sewer drain 71.

The illustrative composting device 110 further includes a filtration system 112 including an active carbon filter 114 and a fan 116 to draw air therethrough from an inlet 115 to an outlet 117. The fan 116 may include a conventional fan motor 118 to drive fan blades 120 in rotation. The fan motor 118 may be in electrical communication with the controller 28. The filtration system 112 is configured to reduce obnoxious odors emanating from solid waste in the storage bin 32. The carbon filter 114 may be slidably received within the housing 26 for ease of removal and replacement. An access panel 119 may also be removably supported by the housing 26 to facilitate access to the rotatable screw 60 and the drive actuator 66.

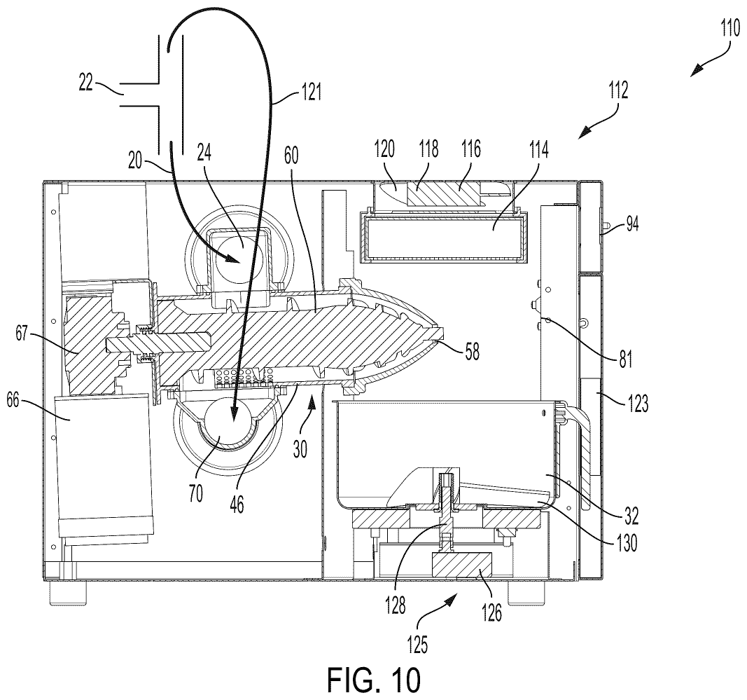

As shown in FIG. 10, if the composting device 110 is overloaded (e.g., the storage bin 32 is full) or broken, flow from the garbage disposal 18 will travel via a bypass 121, avoiding the opening 24 and instead flowing directly into the opening 70. As further detailed herein, flow to the bypass 121 may be controlled via an electrically operable valve. Additionally, a door 123 may be movably supported by the housing 26 to provide access to the storage bin 32. The interlock 81 (e.g., a switch) may provide a signal to the controller 28 such that the operation of the composting device 110 will stop when the door 123 is open.

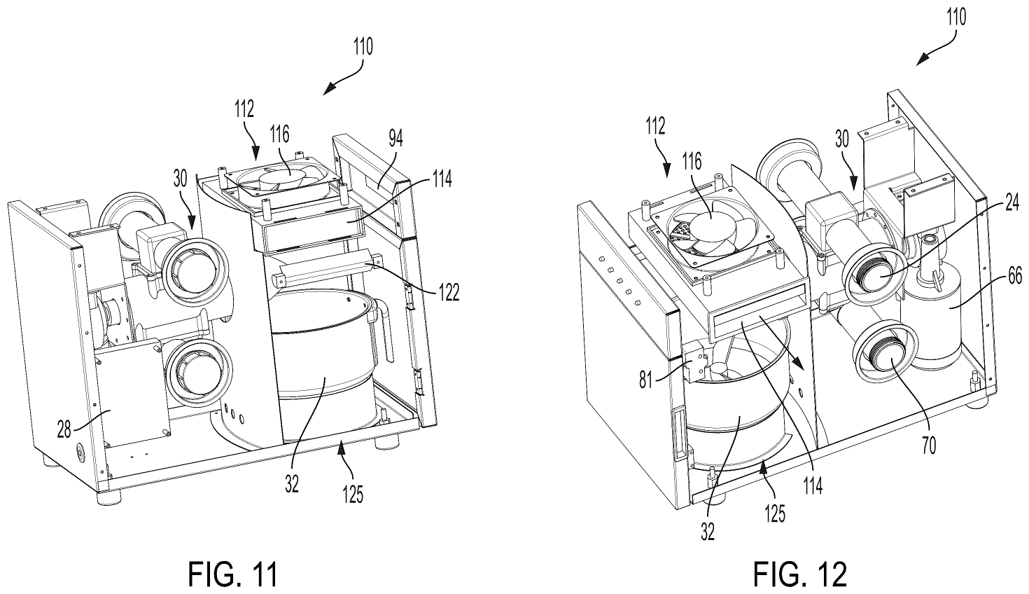

With reference to FIG. 11, an ultraviolet (UV) light 122 may be in electrical communication with the controller 28 to direct UV light to the storage bin 32 (FIG. 11). The UV light 122 is configured to help disinfect the waste material in the storage bin 32.

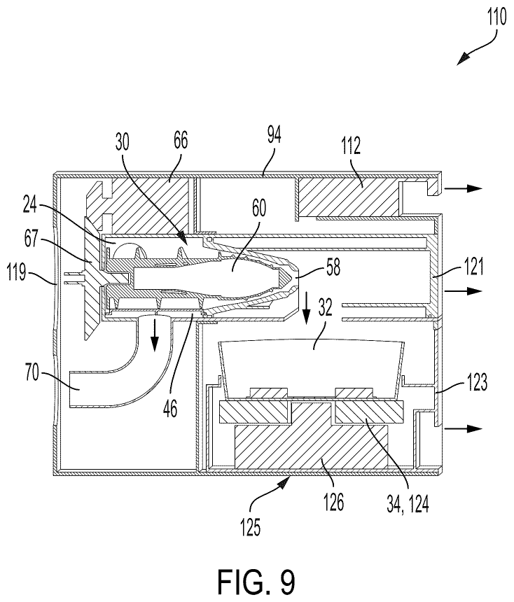

The heating device 34 in the composting device 110 illustratively comprises a heat plate 124 in thermal communication with the storage bin 32 (FIG. 9). A stirring device 125, illustratively including a stirring motor 126 operably coupled to a shaft 128 and a blade 130, may help stir the waste material in the storage bin 32. The motor 124 may be in electrical communication with the controller 28.

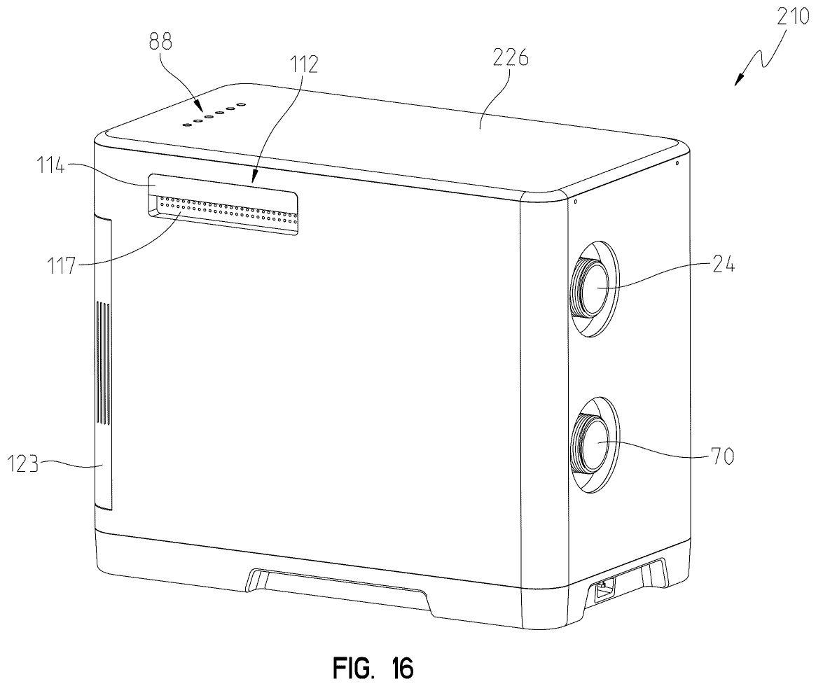

Referring now to FIGS. 13-17, a further illustrative embodiment composting device 210 of the present disclosure is shown as including many similar features to the composting devices 10 and 110 detailed above. As such, in the following description, similar components will be identified with like reference numbers.

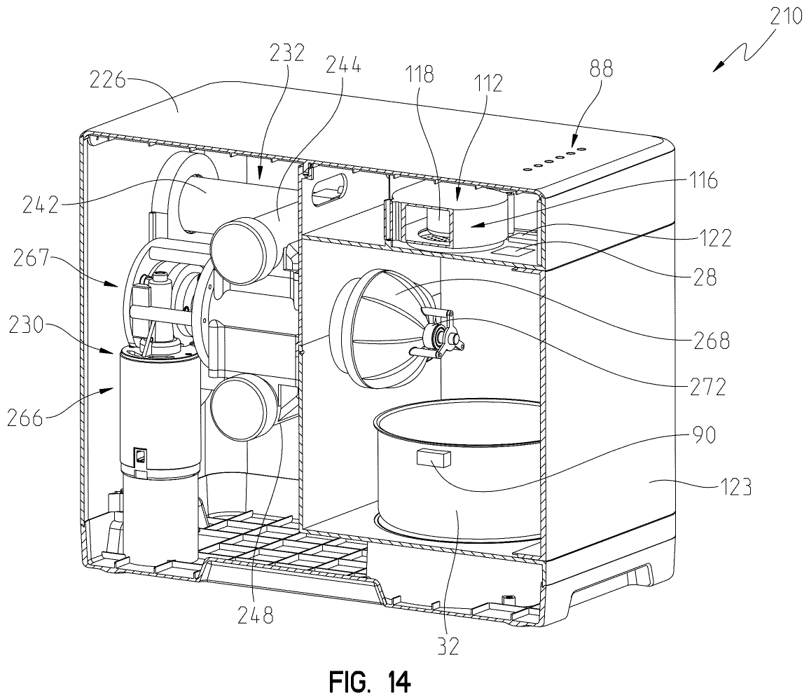

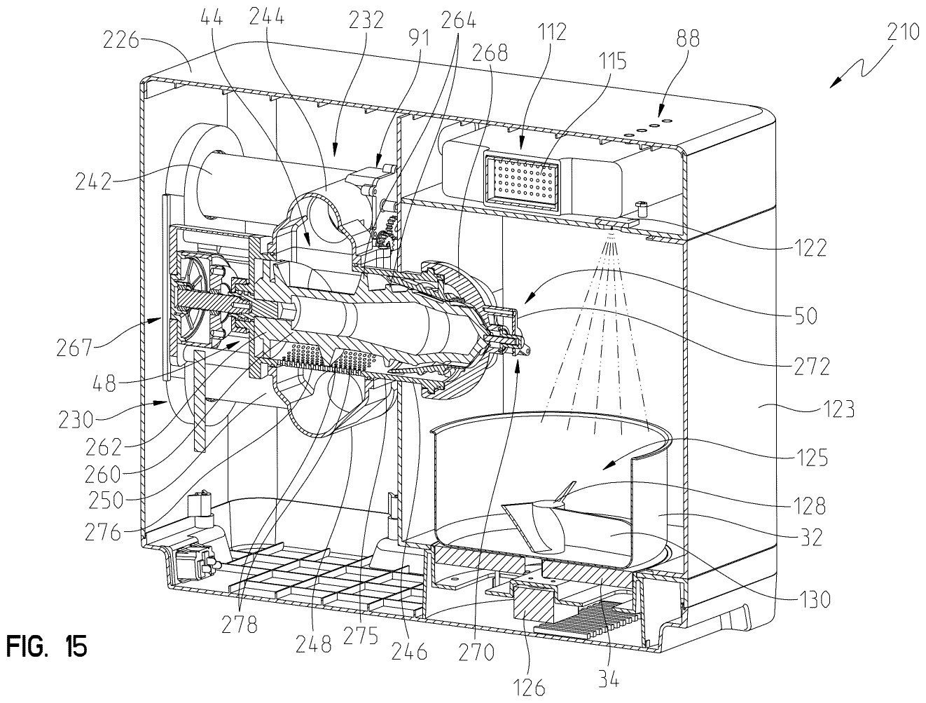

With reference to FIGS. 14 and 15, the composting device 210 illustratively includes a housing 226 receiving the controller 28, a waste separator 230, a fluid pathway assembly 232, and the storage bin or recycling tank 32. The heater 34 and the stirring device 125 are operably coupled to the storage bin 32. The filtration system 112 is illustratively positioned above the storage bin 32 and includes the active carbon filter 114 and the fan 116 to draw air therethrough from the inlet 115 to the outlet 117. The fan 116 may include conventional fan motor 118 to drive fan blades 120 in rotation. As further detailed above, the fan motor 118 may be in electrical communication with the controller 28.

With reference to FIGS. 15-17, the fluid pathway assembly 232 provides selective fluid communication between the waste material housing inlet 24 and the liquid housing outlet 70 via one of (1) the waste separator 230 via the outlet opening 44, and (2) via the bypass 121. More particularly, the fluid pathway assembly 232 includes an inlet tube 242 defining the waste material housing inlet 24 and fluidly coupled to the electrically operable valve 91 which directs fluid flow alternately between (1) a waste separator connecting tube 244 and (2) a bypass tube 245. A diverter tube 248 fluidly couples the waste separator 230 to an outlet tube 250 defining the liquid housing outlet 70. The outlet tube 250 is also fluidly coupled to the bypass tube 245 thereby defining the bypass 121.

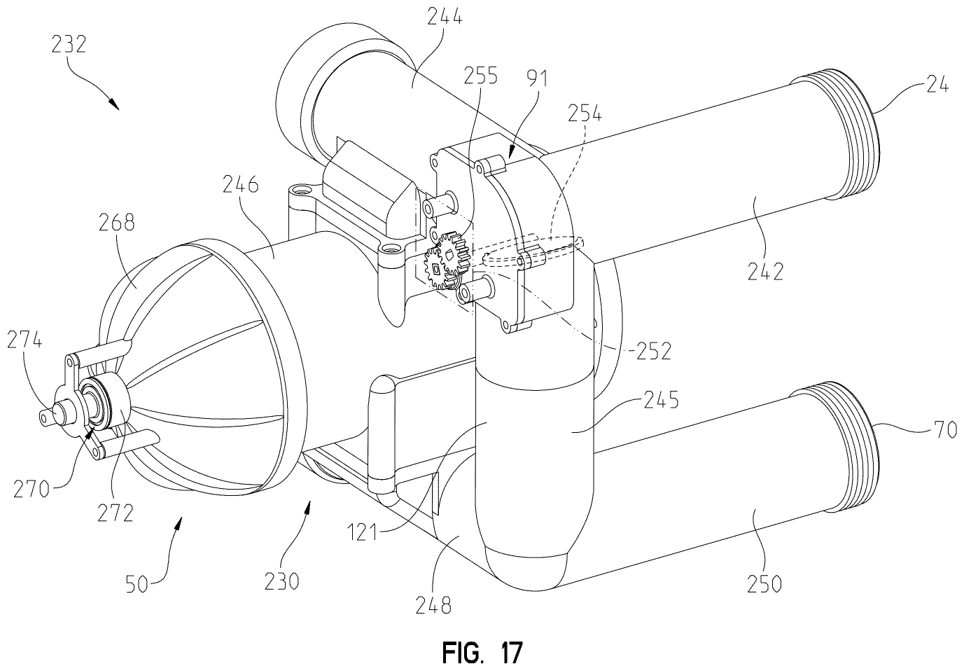

With reference to FIG. 17, the electrically operable valve 91 may be a solenoid valve including a motor 252 driving a valve member 254, illustratively a flapper, via a gear assembly 255. The motor 252 toggles the valve member 254 between a first position and a second position. In the first position, the valve member 254 closes the bypass tube 245 from the waste material housing inlet 24 of the inlet tube 242, while fluidly coupling the tube 244 (and hence the waste separator 230 via the outlet opening 44) with the inlet 24. In turn, the waste separator 230 is fluidly coupled downstream to the diverter tube 248 and hence to the liquid housing outlet 70 via the outlet tube 250. In the second position, the valve member 254 closes the tube 244 (and hence the waste separator 230) from the waste material housing inlet 24, while fluidly coupling the bypass tube 245 with the inlet 24 of the inlet tube 242. In turn, the bypass tube 245 is fluidly coupled to the liquid housing outlet 70 via the outlet tube 250.

With further reference to FIG. 15, the waste separator 230 includes a rotatable screw 260 received within an outer case 246. The rotatable screw 260 illustratively includes a center shaft 262 supporting a plurality of helical threads or discs 264. A drive actuator 266, such as a direct current (DC) electric motor, is operably coupled to the rotatable screw 260 illustratively via a gear assembly 267. Operation of the drive actuator 266 activates the gear assembly 267 thereby causing the screw 260 to rotate, such that the threads 264 move the waste material axially in a direction from the proximal end 48 to the distal end 50.

An end cap 268 is supported by the distal end 50 of the waste separator 230. An outlet 270 is supported by the outer case 246 and positioned above the storage bin 32 for dispensing waste material from the separator 230 into the storage bin 32. The outlet 270 may be opened and closed by a movable closure member 272. Illustratively, the closure member 272 is biased along a guide rod 274 between a first or open position and a second or closed position. The outlet 270 provides fluid communication between the separator 230 and the storage bin 32 in the open position, and the outlet 270 is sealed from communication between the separator 230 and the storage bin 32 in the closed position by the closure member 272. As organic waste in the waste separator 230 moves distally, it illustratively pushes the closure member 272 from the closed position to an open position.

The outer case 246 illustratively includes a cylindrical side wall 275 with a draining mesh 276. The draining mesh 276 illustratively includes a plurality of openings 278 positioned intermediate the inlet opening 44 (adjacent the proximal end 48) and the outlet opening 270 (adjacent the distal end 50). The organic waste and water 45a from the garbage disposal 18 is supplied to the inlet opening 44, while the separated solid waste 45b is supplied to the outlet opening 270.

A door 123 may be movably supported by the housing 226 to provide access to the storage bin 32. The interlock 81 (e.g., a switch) may provide a signal to the controller 28 such that the operation of the composting device 210 will stop when the door 123 is open.

Although the invention has been described in detail with reference to certain preferred embodiments, variations and modifications exist within the spirit and scope of the invention as described and defined in the following claims.

1. A composting device for processing organic waste material from a sink drain, the composting device comprising:
a waste material inlet configured to operably couple with a sink drain;
a waste separator operably coupled to the waste material inlet, the waste separator configured to separate solid waste from liquid in the organic waste material;
wherein the waste separator includes:
an outer case extending axially between a proximal end and a distal end, the outer case having a side wall with a plurality of openings positioned intermediate an inlet opening and an outlet opening,
a rotatable screw received within the outer case, and
an actuator operably coupled to the rotatable screw to cause the screw to rotate and move the waste material axially in a direction from the proximal end to the distal end;
a storage bin positioned to receive the solid waste from the outlet opening of the outer case of the waste separator;
a heater in thermal communication with the storage bin to facilitate dehydrating of the solid waste; and
a liquid outlet fluidly coupled to the waste separator for discharging liquid extracted from the organic waste material.

2. The composting device of claim 1, further comprising:
a controller operably coupled to the actuator of the waste separator and the heater; and
a fill sensor operably coupled to the controller and configured to detect a level of solid waste within the storage bin.

3. The composting device of claim 2, further comprising an electrically operable bypass valve fluidly coupled to the waste separator and configured to direct water to the liquid outlet in response to the fill sensor sending a signal to the controller.

4. The composting device of claim 2, further comprising an alarm configured to provide an indication to a user in response to the fill sensor sending a signal to the controller.

5. The composting device of claim 1, further comprising a housing receiving the waste separator and the heater, wherein the storage bin is removably received within the housing.

6. The composting device of claim 5, further comprising a port formed within the housing to access the waste separator.

7. The composting device of claim 1, further comprising a carbon filter supported proximate the storage bin.

8. The composting device of claim 7, further comprising a fan configured to draw air from the storage bin through the carbon filter.

9. The composting device of claim 1, further comprising an ultra-violet light configured to treat the solid water supplied to the storage bin.

10. The composting device of claim 1, wherein a garbage disposal is fluidly coupled to the sink drain.

11. A composting device for processing organic waste material from a sink drain, the composting device comprising:
a waste material inlet configured to operably couple with a sink drain;
a waste separator operably coupled to the waste material inlet, the waste separator configured to separate solid waste from liquid in the organic waste material;
a storage bin positioned to receive the solid waste from the waste separator;
a heater in thermal communication with the storage bin to facilitate dehydrating of the solid waste;
a liquid outlet fluidly coupled to the waste separator for discharging liquid extracted from the organic waste material;
a controller operably coupled to the actuator of the waste separator and the heater;
a housing receiving the waste separator and the heater, wherein the storage bin is removably received within the housing; and
a fill sensor operably coupled to the controller and configured to detect a level of solid waste within the storage bin.

12. The composting device of claim 11, further comprising an electrically operable bypass valve fluidly coupled to the waste separator and configured to direct water to the liquid outlet in response to the fill sensor sending a signal to the controller.

13. The composting device of claim 11, further comprising an alarm configured to provide an indication to a user in response to the fill sensor sending a signal to the controller.

14. The composting device of claim 11, further comprising a port formed within the housing to access the waste separator.

15. The composting device of claim 11, further comprising a carbon filter supported proximate the storage bin.

16. The composting device of claim 15, further comprising a fan configured to draw air from the storage bin through the carbon filter.

17. The composting device of claim 11, further comprising an ultra-violet light configured to treat the solid water supplied to the storage bin.

18. The composting device of claim 11, wherein a garbage disposal is fluidly coupled to the sink drain.

19. The composting device of claim 11, wherein the waste separator includes:
an outer case extending axially between a proximal end and a distal end, the outer case having a side wall with a plurality of openings positioned intermediate an inlet opening and an outlet opening;
a rotatable screw received within the outer case; and
an actuator operably coupled to the rotatable screw to cause the screw to rotate and move the waste material axially in a direction from the proximal end to the distal end.

20. A composting device for processing organic waste material from a sink drain, the composting device comprising:
a waste material inlet configured to operably couple with a sink drain;
a waste separator operably coupled to the waste material inlet, the waste separator configured to separate solid waste from liquid in the organic waste material;
wherein the waste separator includes:
an outer case extending axially between a proximal end and a distal end, the outer case having a side wall with a plurality of openings positioned intermediate an inlet opening and an outlet opening,
a rotatable screw received within the outer case, and
an actuator operably coupled to the rotatable screw to cause the screw to rotate and move the waste material axially in a direction from the proximal end to the distal end;
a storage bin positioned to receive the solid waste from the outlet opening of the outer case of the waste separator;
a heater in thermal communication with the storage bin to facilitate dehydrating of the solid waste;
a liquid outlet fluidly coupled to the waste separator for discharging liquid extracted from the organic waste material;
a controller operably coupled to the actuator of the waste separator and the heater;
a housing receiving the waste separator and the heater, wherein the storage bin is removably received within the housing;
a fill sensor operably coupled to the controller and configured to detect a level of solid waste within the storage bin; and
wherein a garbage disposal is fluidly coupled to the sink drain.

21. The composting device of claim 20, further comprising an alarm configured to provide an indication to a user in response to the fill sensor sending a signal to the controller.

22. The composting device of claim 21, further comprising an electrically operable bypass valve fluidly coupled to the waste separator and configured to direct water to the liquid outlet in response to the fill sensor sending a signal to the controller.

23. The composting device of claim 20, further comprising a port formed within the housing to access the waste separator.

24. The composting device of claim 20, further comprising:
a carbon filter supported proximate the storage bin; and
a fan configured to draw air from the storage bin through the carbon filter.

25. The composting device of claim 20, further comprising an ultra-violet light configured to treat the solid water supplied to the storage bin.
